(19) United States
(12) Patent Application Publication
(10) Pub. No.: US 2017/0178253 A1
(43) Pub. Date: Jun. 22, 2017

(54) USER DATA STORE FOR ONLINE ADVERTISEMENT EVENTS

(71) Applicant: LinkedIn Corporation, Mountain View, CA (US)

(72) Inventors: Christos Koufogiannakis, Menlo Park, CA (US); Lihong Pei, Mountain View, CA (US); Hardik N. Bati, Santa Clara, CA (US)

(21) Appl. No.: 14/975,735

(22) Filed: Dec. 19, 2015

(51) Int. Cl. G06Q 50/00; G06Q 30/02

(52) U.S. Cl. CPC G06Q 50/01; G06Q 30/0254

(57) ABSTRACT

A machine may be configured to manage user data in a user data store. For example, the machine identifies a rule associated with a campaign for serving online ads in a social networking service (SNS). The rule specifies a maximum number of user events associated with the online ads included in the campaign to occur during a time window, for a member of the SNS. The machine identifies a bucket that stores metadata pertaining to user events associated with the particular member that occurred during a time period that corresponds to the time window specified in the rule. The machine performs an analysis of the metadata pertaining to the user events associated with the particular member that occurred during the time window specified in the rule. The machine determines that, for the particular member, the rule is not violated based on the performing of the analysis of the metadata.

### TECHNICAL FIELD

The present application relates generally to the processing of data, and, in various example embodiments, to systems, methods, and computer program products for managing and using data in a user data store.

### BACKGROUND

It is common for operators of web sites to record visits and site activities of the users who log into their web sites in a database associated with the web site. One way to do that is to maintain, for every user of the web site, a log file that stores information about everything that the user has done on the web site during a particular period of time (e.g., a month, a year, etc.). The information stored for each user of the web site may include impressions, clicks, or other events associated with various online ad campaigns (also “campaigns”). This information may be stored chronologically in the log file. The log files are often quite large due to storing records of the large number of online actions some users may engage in when visiting the web site.

Often, an ad system associated with a web site causes the display of online advertising targeted to particular web site users. To avoid showing the same online ad to a particular user beyond a desired number of times, the ad system may enforce an ad display frequency capping rule. For example, such a rule may specify that the users of the web site should have no more than three impressions of an ad included in a campaign in the last twenty-four hours. To determine whether the ad should be shown to a particular user, the ad system may evaluate this rule against the online activity data available for the particular user. The ad system may access the log file associated with the particular user, scan the log file from the beginning of the log file to the end until it finds an entry that has a timestamp of more than twenty-four hours before. As the ad system scans the log file associated with the user, the ad system counts user events within each campaign (e.g., impressions, clicks, etc.) for one or more campaigns. Upon encountering a user event that is older than twenty-four hours, the ad system determines whether the rule is violated based on counting the number of impressions of the particular ad in the last twenty-four hours, and comparing the number of impressions and the maximum number of impressions specified in the rule (e.g., three impressions).

Thus, every time the ad system determines whether a frequency rule is violated, the ad system scans large log files and counts various types of events. For every single ad request, the ad system undergoes this scanning and counting process. This often results in slow data processing times and slow ad presentation to users of the web site.

The success of the web site operator in providing a quality user experience depends largely on fast delivery of information including online advertising. To deliver online information in a timely fashion, it is helpful to employ efficient storage for large volumes of data and data management systems that provide improved data processing speeds.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a block diagram illustrating components of a user data management system, according to some example embodiments;

FIG. 3 is a diagram illustrating a representation of a plurality of user data buckets associated with a member of a Social Networking Service (SNS) and ordered chronologically, according to some example embodiments;

FIG. 4 is a diagram illustrating a representation of a user data bucket associated with a member of the SNS, according to some example embodiments;

FIG. 5 is a diagram illustrating a representation of a plurality of user data buckets associated with a member of the SNS for evaluating a frequency rule, according to some example embodiments;

FIG. 6 is a diagram illustrating a data flow for evaluating rules against user events in user data buckets, according to some example embodiments;

FIG. 7 is a diagram illustrating a data flow for updating user data buckets with user event data, according to some example embodiments;

FIG. 8 is a diagram illustrating a representation of a plurality of user data buckets associated with a member of the SNS for evaluating a fraud rule, according to some example embodiments;

FIG. 9 is a flowchart illustrating a method for managing and using data in a user data store, according to some example embodiments;

FIG. 10 is a flowchart illustrating a method for managing and using data in a user data store, and representing step 906 of the method illustrated in FIG. 9 in more detail, according to some example embodiments;

FIG. 11 is a flowchart illustrating a method for managing and using data in a user data store, and representing steps 904 and 906 of the method illustrated in FIG. 9 in more detail, according to some example embodiments;

FIG. 12 is a flowchart illustrating a method for managing and using data in a user data store, and representing step 1112 of the method illustrated in FIG. 11 in more detail, and additional steps of the method illustrated in FIG. 11, according to some example embodiments;

FIG. 13 is a flowchart illustrating a method for managing and using data in a user data store, and representing additional steps of the method illustrated in FIG. 9, according to some example embodiments;

FIG. 14 is a flowchart illustrating a method for managing and using data in a user data store, and representing additional steps of the method illustrated in FIG. 13, according to some example embodiments;

FIG. 15 is a flowchart illustrating a method for managing and using data in a user data store, and representing an additional step of the method illustrated in FIG. 9, according to some example embodiments;

FIG. 16 is a block diagram illustrating a mobile device, according to some example embodiments; and

FIG. 17 is a block diagram illustrating components of a machine, according to some example embodiments, able to read instructions from a machine-readable medium and perform any one or more of the methodologies discussed herein.

### DETAILED DESCRIPTION

Example methods and systems for managing and using data in a user data store are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

Traditionally, the online activity of a user of a web site is recorded in a log file associated with a user identifier of the user. The user may be a member of a Social Networking Service (SNS) like LinkedIn®, and the web site may be a web site of the SNS. The log file associated with the member may include all of the online ad impressions served to the member, the clicks by the member, social media actions such as “likes,” “follows,” etc., or other events (e.g., user actions, such as visits to web sites, etc.) associated with or by the member during a period of time (e.g., a year). Due to the large volume of online activity by the member at the web site, the log file associated with the member may become quite large. The scanning of such a large log file and the identifying of sought data may become slower as the number of entries in the log file increase. For example, before an online ad is selected for display to a particular member of the SNS, a frequency rule that imposes a limit on the number of times the ad can be shown to a user is evaluated against the user data included in the log file associated with the particular member. To determine whether the frequency rule is violated, the user data included in the log file is scanned and a counter is kept to count the number of user events of a particular type (e.g., impressions, clicks, or other events) that occurred during the time specified by the frequency rule. The log file associated with the particular member is likely to be large if the period that it covers is large (e.g., a year). If the particular member is an active user of the web site, the log file may be even larger. It may be beneficial for the operator of the web site to provide a more efficient storage mechanism for increased volumes of data and a data management system that improves data processing speeds.

In some example embodiments, a user data management system identifies a rule associated with a campaign for serving online ads in the SNS. The rule may specify a maximum number of user events associated with the online ads included in the campaign to occur during a time window, for a member of the SNS. Based on the rule and a member identifier of a particular member of the SNS, the user data management system identifies a data bucket (also referred to as “bucket”) associated with the member identifier. The bucket may store metadata pertaining to user events associated with the particular member that occurred during a time period that corresponds to the time window specified in the rule. The user data management system may perform an analysis of the metadata pertaining to the user events associated with the particular member that occurred during the time window specified in the rule. The user data management system may determine that, for the particular member, the rule is not violated based on the performing of the analysis of the metadata. If the rule is determined to not be violated, then the user data management system may generate a communication including an indication that an online ad included in the campaign may be served to the particular member. The user data management system may transmit the communication to an ad server that serves online ads to the particular member.

The user data management system may evaluate the user event data according to various rules. Some rules govern the frequency with which ads should be displayed to members. Some rules are used to identify fraudulent members. Some rules govern re-targeting members for various campaigns. Some rules may be used to perform debugging, investigative, or customer service functions.

In certain example embodiments, the user data management system stores user events associated with the member in various buckets associated with a member. A bucket may be a database record that stores user events (e.g., impressions, clicks, social media actions, other user behavior, etc.) associated with a member for a particular window of time (e.g., an hour, twenty-four hours, seven days, one month, three months, etc.). The buckets associated with the member may be included in a user data store that stores a plurality of buckets associated with a plurality of members of the SNS. Some buckets may store member activity and behavior data (e.g., user events such as impressions, clicks, social media actions, etc.). Other buckets may store member profile data of the members of the SNS.

In some example embodiments, the user data store is a time-series storage. In various example embodiments, the user data store is a document-oriented database system wherein each bucket can be mapped to one or more documents. In certain example embodiments, the user data store is a column-oriented database system wherein each bucket of the user data store can be mapped to a column.

The data for a particular member may be stored in many buckets. To uniquely identify a bucket, in certain example embodiments, each bucket that stores data for a member is associated with a key that includes two parts (also referred to as a “composite key”): a member identifier (ID) of the particular member and a bucket ID that represents a particular period of time. The bucket ID, in some instances includes a string that represents the time interval for the user events stored in the bucket. For example, the bucket that stores the daily data for Dec. 15, 2015 for member U1234 is identified by a composite key “U1234.12152015.”

A bucket associated with a member may include user events (or descriptions of user events) for the member grouped by campaigns that include particular user events. The bucket also includes metadata pertaining to the user events, such as counts for each event type (e.g., an impressions count, a clocks count, or an other events count) for the events associated with each campaign, and total events counts for each event type that represent the total number of events of particular types in all the campaigns referenced in the bucket. One or more counts in the bucket are updated every time a user event is added to (or removed from) the bucket.

In various example embodiments, for a given member, there are several buckets. For example, a one-hour bucket associated with the member includes a list of impressions, a list of clicks, and a list of other events associated with or by the member over an hour long time interval (e.g. starting at 2 pm and ending at 3 pm), sorted based on the time of occurrence of each of these events. Another bucket, a twelve-hour bucket, associated with the member includes a list of impressions, a list of clicks, and a list of other events associated with or by the member over a twelve hour time interval, sorted based on the time of occurrence of each of these events. In some instances, there is some redundancy between the data in the one-hour bucket and the twelve-hour bucket: all the events appearing in the one-hour bucket also appear in the twelve-hour bucket. In addition, the twelve-hour bucket includes another eleven hours of user events associated with the particular member. The particular member may also be associated with a number of other buckets such as a 24-hour bucket, a 7-day bucket, a one-month bucket, a three-month bucket, etc. Additional buckets may also be defined.

With an increase in the number of buckets, there is an increase in the storage space and an increase in bucket updating time. In some example embodiments, only buckets that are more frequently used are maintained by the user data management system. For example, if most of the campaigns define rules that deal with the last one hour, the last twelve hours, the last day, or the last week, then these should be the buckets most used for retrieval of information to evaluate the rules.

The user event data may be pre-processed in the various buckets such that when event data is requested for a particular time window, that data is already available. For example, as one or more buckets (e.g., a one-hour bucket, a 24-hour bucket, etc.) associated with a member are updated, by the user data management system, to include a recent click by the member on an ad included in a first campaign, the user data management system also increases a count of clicks for the first campaign in each of the one or more buckets associated with the member. Also, the user data management system increases a total count of clicks for all the campaigns in each of the one or more buckets associated with the member. The campaign event type count and the total event count may be part of the metadata pertaining to user events and are included in the buckets associated with the member.

In some example embodiments, the user data management system can identify, based on the time window specified in the rule, which one or more buckets associated with the user to access, and can quickly determine the number of events of a particular type based on identifying the event type count corresponding to the particular type of event regulated by the rule. Accordingly, the scanning of the entire list of user events stored in a bucket may be avoided. For example, the user data management system receives a request from an ad server to evaluate a frequency rule for a campaign against the user data of a member. The request may include a member identifier, a campaign identifier, and a reference to the frequency rule (e.g., a rule identifier). The frequency rule associated with a first campaign states “ten impressions in the last seven days.” Based on the frequency rule, the user data management system identifies the time window in the frequency rule as “last seven days,” identifies the type of user event as “impression,” and identifies the maximum number of events as “ten.” Based on the request from the ad server, the user data management system determines the member identifier. The user data management system accesses the last seven day bucket associated with the member based on the member identifier. The user data management system accesses the impressions count in the last seven day bucket associated with the member. The impressions count identifies the number of impressions of ads (e.g., eight) included in the first campaign that were served to the member in the last seven days. The user data management system compares the number of impressions identified by the impressions count (e.g., eight) and the maximum number of events specified in the frequency rule (e.g., ten), and determines that the frequency rule associated with the first campaign is not violated for the member. The user data management system transmits, in response to the request, a communication to the ad server. The communication includes an indication that the frequency rule associated with the first campaign is not violated for the member.

In certain example embodiments, the user data management system may scan the user events listed in one or more buckets. This may happen, for instance, when the time window specified in a frequency rule may not be matched to an exact corresponding bucket. For example, the user data store includes an hour bucket for every clock hour for each of the members of the SNS. A frequency rule specifies a “last 3 hours” window. The current time is 2:35 pm. The last three hours are between 11:35 am and 2:35 pm. That interval is covered by four hour buckets: 11 am-12 pm, 12 pm-1 pm, 1 pm-2 pm, and 2 pm-3 pm. Because the bucket associated with the 11 am-12 pm period includes user events outside the time window specified by the frequency rule, the user data management system cannot use the event counts in this bucket. Instead, the user data management system scans and counts the user events (that are chronologically sorted) in this bucket starting from the most recent ones until it detects a user event that has a timestamp older than 11:35 am. The user data management system uses the event counts for the 12 pm-1 pm and 1 pm-2 pm time periods because all the user events in these two buckets are included in the time window specified by the frequency rule. For the bucket associated with the 2 pm-3 pm time period, the user data management system uses the event counts because all the user events in this bucket are included in the time window specified by the frequency rule even though this bucket is not closed (e.g., another twenty-five minutes-worth of event data may be stored in this bucket).

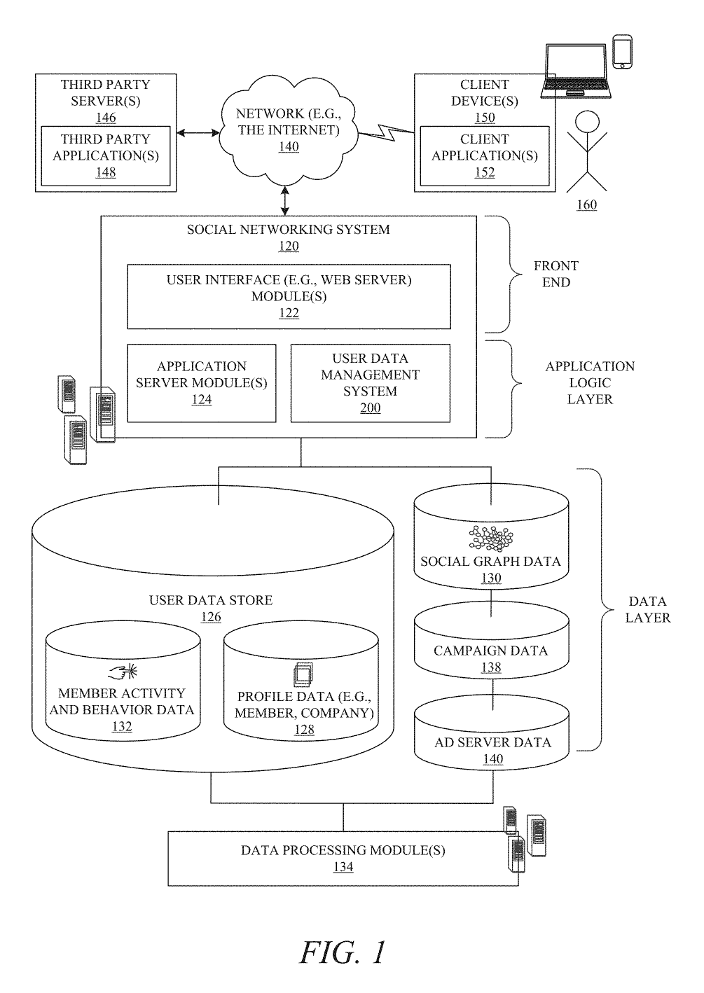

An example method and system for managing and using data in a user data store may be implemented in the context of the client-server system illustrated in FIG. 1. As illustrated in FIG. 1, the user data management system 200 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 140 to exchange information with the social networking system 120. Each of the client devices 150 may comprise a computing device that includes at least a display and communication capabilities with the network 140 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130.

In some example embodiments, members may receive advertising targeted to them based on various factors (e.g., member profile data, social graph data, member activity or behavior data, etc.). According to certain example embodiments, one or more members may receive career-related communications targeted to the one or more members based on various factors (e.g., member profile data, social graph data, member activity or behavior data, etc.). The advertising or career-related communications may be associated with (e.g., included in) various types of media, such as InMail, Display Ads, Sponsored Updates, etc. Based on the interactions by the one or more members with the media or the content of the media, the interest of the one or more members in the advertising or career-related communications may be ascertained.

In some example embodiments, the advertising or career-related communications are based on various types of data associated with a campaign (e.g., a duration of the campaign, a creative that includes campaign content, target criteria for targeting members, a target group of members, various budget values, etc.). The data associated with a campaign may be stored in a campaign database 138.

As the campaign content is delivered (e.g., communicated) to one or more members, data pertaining to the delivery of the campaign is stored in a record of ad server database 140. For example, as impressions of an ad included in a campaign are delivered to members, a record in ad server database 140 is created (or updated) to track the number of served impressions or clicks by the members, delivered revenue associated with the served impressions or with the clicks, remaining budget values, etc. If a member interacted with a particular item of digital media (e.g., clicked a button in a user interface displaying campaign content, subscribed to “follow” another member or company, “liked” an item of digital content, etc.), a record of member activity and behavior database 132 may also be created (or updated) to reflect the member interaction.

In some example embodiments, one or more of the databases discussed herein are included in a user data store 126. For example, as shown in FIG. 1, the member activity and behavior database 132 and the profile database 128 are included in the user data store 126. The user data store 126 may be a database system which, in some instances, is a distributed database system with various records hosted by a number of different machines.

The user data stored in the user data store 126 may be stored in buckets associated with particular members. A bucket may be a database record that stores user events (e.g., impressions, clicks, social media actions, other user behavior, etc.) associated with a member of the SNS for a particular window of time (e.g., an hour, twenty-four hours, seven days, one month, three months, etc.). In some example embodiments, the user data store 126 is a time-series storage. In various example embodiment, the user data store 126 is a document oriented database system wherein each bucket can be mapped to one or more documents. In certain example embodiments, the user data store 126 is a column-oriented database system wherein each bucket of the user data store 126 can be mapped to a column.

A bucket associated with a member may include user events (or descriptions of user events) for the member grouped by campaigns that include particular user events. The bucket also includes counts for each event type (e.g., an impressions count, a clocks count, or an other events count) for the events associated with each campaign, and total events counts for each event type that represent the total number of events of particular types in all the campaigns referenced in the bucket. One or more counts in the bucket are updated every time a user event is added to (or removed from) the bucket.

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124.

Other applications and services may be separately embodied in their own application server modules 124. As illustrated in FIG. 1, social networking system 120 may include the user data management system 200, which is described in more detail below.

Further, as shown in FIG. 1, a data processing module 134 may be used with a variety of applications, services, and features of the social networking system 120. The data processing module 134 may periodically access one or more of the databases 128, 130, 132, 138, or 140, process (e.g., execute batch process jobs to analyze or mine) profile data, social graph data, member activity and behavior data, campaign data, or ad server data, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers of a large-scale distributed storage and processing framework, such as Hadoop servers, for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

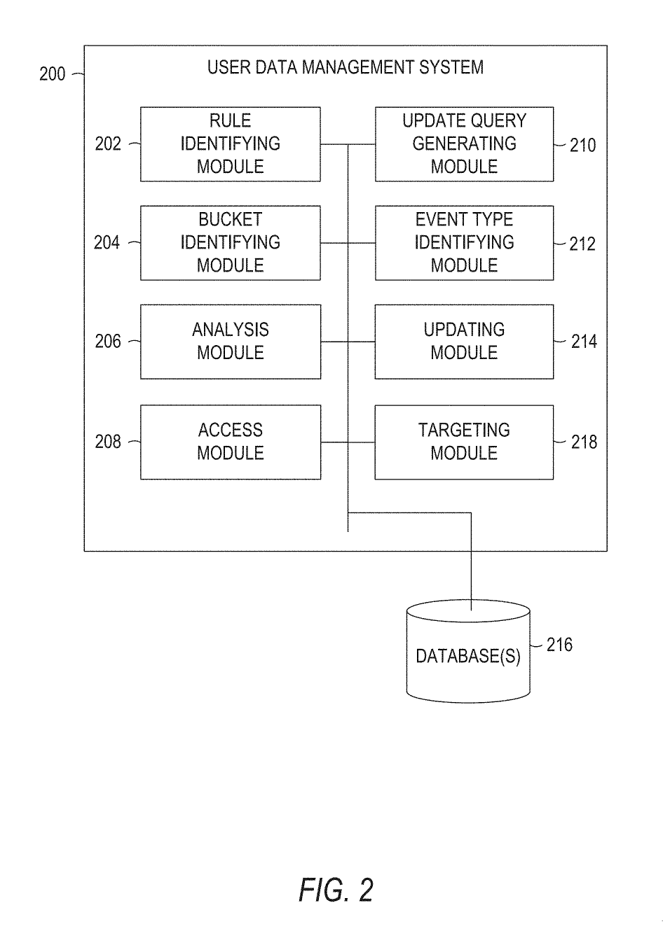

FIG. 2 is a block diagram illustrating components of the user data management system 200, according to some example embodiments. As shown in FIG. 2, the user data management system 200 includes a rule identifying module 202, a bucket identifying module 204, an analysis module 206, an access module 208, an update query generating module 210, an event type identifying module 212, an updating module 214, and a targeting module 214, all configured to communicate with each other (e.g., via a bus, shared memory, or a switch).

According to some example embodiments, the rule identifying module 202 identifies a rule associated with a campaign for serving online ads in a social networking service (SNS). The rule may be stored in a database 216 (e.g., the campaign database 138). The rule specifies a maximum number of user events associated with the online ads included in the campaign to occur during a time window, for a member of the SNS. The rule may specify the maximum number of user events of a particular type (e.g., impressions, clicks, other events).

In some example embodiments, the rule identifying module 202 accesses the rule in the database 216. In other example embodiments, an ad serving system transmits a request for evaluation of the rule against user event data associated with the member. The request may include the rule. Alternately, the request may reference the rule.

The bucket identifying module 204 identifies a bucket that stores metadata pertaining to user events associated with the particular member that occurred during a time period that corresponds to the time window specified in the rule. The identifying of the bucket may be based on the rule and a member identifier of a particular member of the SNS. In some instances, the metadata includes one or more values that identify one or more numbers of user events of one or more types that occurred during the time period associated with the bucket. In some instances, the metadata includes at least one of a count of impressions served to the particular member, a count of clicks by the particular member, or a count of other events associated with or by the particular member.

The bucket may also include one or more lists of user events associated with the particular member. Each of the one or more lists groups user events by type (e.g., impressions, clicks, or other events). The user events in each list may be ordered in chronological order, or reverse chronological order. After a new user event is registered (e.g., a new impression of an online ad is served to the member), the new user event is added to the list that corresponds to the type of user event in one or more buckets associated with the member. Also, after the new user event is registered, a count corresponding to the type of user event is increased for the campaign that includes the ad associated with the user event in the one or more buckets associated with the member. Further, a total count that corresponds to the type of user event and that tallies all user events of that type in all the campaigns referenced in the one or more buckets is increased in the one or more buckets.

In various example embodiments, the bucket is associated with the particular member and includes a mapping from a campaign identifier of the campaign to at least one of a list of impressions associated with the campaign identifier provided to the particular member, a list of clicks associated with the campaign identifier by the particular member, or a list of other events associated with the campaign identifier and the particular member.

In some example embodiments, the identifying of the bucket includes selecting one or more buckets from a plurality of buckets associated with the particular member based on determining that the one or more buckets include metadata pertaining to one or more user events that occurred during time periods associated with the one or more buckets. Certain buckets associated with the member that do not include data (e.g., user event data, metadata, etc.) for the time periods associated with the certain buckets are not selected for analysis.

In various example embodiments, the identifying of the bucket includes identifying one or more buckets, including the bucket, that store user events associated with the particular member and that are associated with one or more time periods, including the time period, that include (e.g., correspond to, comprise, together include, cover, etc.) the time window specified in the rule. For example, the current time is 2:35 pm. A frequency rule specifies a “last 2 hours” rule. Three one-hour buckets for the time periods of 12 pm-1 pm, 1 pm-2 pm, and 2 pm-3 pm together cover (e.g., include) the time window specified in the rule.

According to another example, the current time is Wednesday, 2:35 pm. A frequency rule specifies a “last 5 days” rule. An evaluation of the rule may be based on analyzing one seven-day bucket. Another evaluation of the rule may be based on analyzing six one-day buckets.

The analysis module 206 performs an analysis of the metadata pertaining to the user events associated with the particular member that occurred during the time window specified in the rule. The analysis module 206 also determines that, for the particular member, the rule is not violated based on the performing of the analysis of the metadata.

In some example embodiments, the rule specifies a maximum number of user events of a particular type, and the metadata includes counts of user events of one or more types. The performing of the analysis includes accessing a count of the user events of the particular type in the bucket, and comparing the count of the user events of the particular type and the maximum number of user events of the particular type specified in the rule.

According to some example embodiments, the determining that, for the particular member, the rule is not violated includes determining that an ad included in the campaign should be displayed in a user interface of a device associated with particular member.

In certain example embodiments, the rule specifies a maximum number of user events of a particular type. The identifying of the bucket includes determining, based on the time window specified in the rule, one or more buckets associated with the particular member to be accessed (e.g., by the analysis module 206). The determining, based on the time window specified in the rule, of the one or more buckets may include matching the time window and one or more time periods associated with the one or more buckets. The performing of the analysis includes: accessing the one or more buckets in reverse chronological order based on time periods associated with the one or more buckets, identifying a first bucket of the one or more buckets that includes metadata that references a first number of user events of the particular type, identifying a second bucket of the one or more buckets that includes metadata that references a second number of user events of the particular type, computing a total value of user events of the particular type in the first and second buckets, and comparing the total value of user events and the maximum number of user events of the particular type specified in the rule.

In some instances, the performing of the analysis further includes: comparing the first number of user events of the particular type and the maximum number specified in the rule, and determining that the maximum value exceeds the first number. The computing of the total value may include aggregating the first number of user events of the particular type and the second number of user events of the particular type based on the determining that the maximum number exceeds the first number of user events. If, in some instances, the comparing of the first number of user events of the particular type and the maximum number specified in the rule results in a determination that the first number of user events exceeds the maximum value specified in the rule, the metadata in the second bucket is not analyzed, and the performing of the analysis stops. A further determination is made that, for the particular member, the rule is violated based on the determination that the first number of user events exceeds the maximum value specified in the rule.

According to some example embodiments, the identifying of the rule, the identifying of the bucket, and the determining that, for the particular member, the rule is not violated are performed in real time based on an indication that the particular member has logged into a web site of the SNS.

The access module 208 accessing (e.g., receives) a description of a user event. The description of the user event may be included in a communication received by the user data management system 200 from a tracking system that tracks user events. The description includes at least one of a member identifier of the particular member, a timestamp of the user event, a type of the user event, or a campaign identifier. Based on the communications received from the tracking system, the user data management system 200 records descriptions of user events in lists of user event descriptions based on the types of user events in various buckets.

The update query generating module 210 generates one or more update queries for one or more buckets associated with the particular member including the bucket to record the description of the user event. The generating of the one or more update queries may be based on the accessing of the description of the user event. The update query generating module 210 also issues the one or more update queries to the one or more buckets associated with the particular member. The issuing of the one or more update queries may be based on the generating of the one or more update queries. The one or more update queries may reference (e.g., include) the description of the user event.

According to some example embodiments, the accessing of the description of the rule, the generating of the one or more update queries, and the issuing of the one or more update queries are performed in real time based on an indication that the particular member has logged into a web site of the SNS.

The event type identifying module 212 identifies the type of user event associated with the user event based on the description of the user event.

The updating module 214, based on the issuing of the one or more update queries, adds the description of the user event to a list of user event descriptions of the identified type in the one or more buckets. The updating module 214 also increases a list count that identifies a number of user event descriptions in the list of the identified type. The updating module 214 also increases a total count that identifies a total number of user event descriptions of the identified type in the one or more buckets.

The targeting module 214 determines that the particular member is a target member for the campaign. The determining may be based on one or more targeting criteria for identifying members of the SNS for presentation of online ads.

In some example embodiments, the user data management system 200 includes additional modules. For example, a communication module generates a communication pertaining to the determination that, for the particular member, the rule is not violated based on the performing of the analysis of the user event data in the bucket (e.g., the metadata). The communication module also transmits the communication to an ad serving system to inform the ad serving system that the particular member may be shown an ad included in the campaign. The transmitting of the communication may be based on a previously received request from the ad serving system to evaluate the rule associated with the campaign against the user event data associated with the particular member. The request may be received by the communication module of the user data management system 200.

To perform one or more of its functionalities, the user data management system 200 may communicate with one or more other systems. For example, an integration engine may integrate the user data management system 200 with one or more email server(s), web server(s), one or more databases, or other servers, systems, or repositories.

Any one or more of the modules described herein may be implemented using hardware (e.g., one or more processors of a machine) or a combination of hardware and software. For example, any module described herein may configure a hardware processor (e.g., among one or more processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 216 (e.g., database 128, 130, 132, 138, or 140).

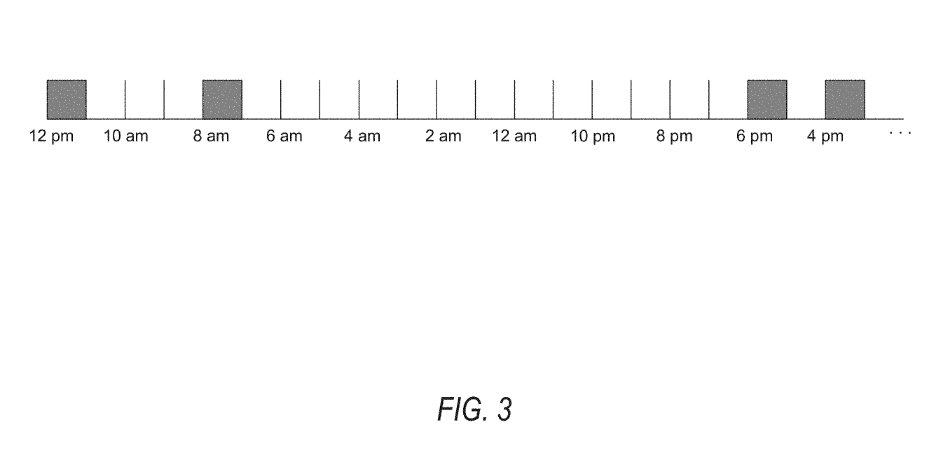

FIG. 3 is a diagram illustrating a representation of a plurality of user data buckets associated with a member and ordered chronologically, according to some example embodiments. In certain example embodiments, the user data management system 200 only creates a particular bucket associated with a particular period of time if there is at least one user event associated with the member during the particular period of time. According to an example, the buckets shown in FIG. 3 are the only one-hour buckets associated with a member in the last twenty-four hours because the member is associated with user events between 3 pm and 4 pm, 5 pm and 6 pm, 7 am and 8 am, and 11 am and 12 pm.

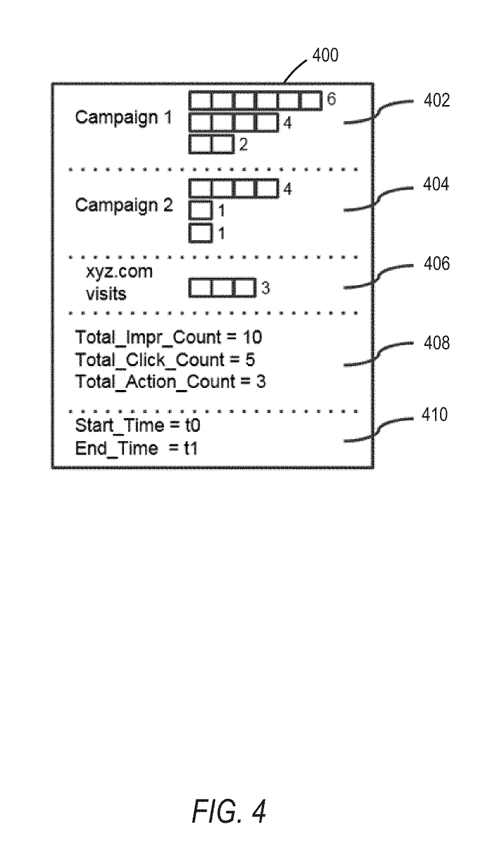

FIG. 4 is a diagram illustrating a representation of a user data bucket associated with a member, according to some example embodiments. Each bucket 400 is associated with a particular period of time and includes a number of areas for various types of data. As shown in FIG. 4, bucket 400 includes area 402 corresponding to Campaign 1 and area 404 corresponding to Campaign 2. Area 402 includes a number of lists of user events (or user event descriptions) of various types and corresponding counts that tally the number of user events of the various types in Campaign 1. Similarly, area 404 includes a number of lists of user events (or user event descriptions) of various types and corresponding counts that tally the number of user events of the various types in Campaign 2.

Accordingly, as shown in FIG. 4, the user data management system 200, for every campaign for which the member had events during the particular time, counts and chronologically sorts a list of impressions that occurred during the particular time, a list of clicks by the member during the particular time, and a list of other actions associated with the campaign that occurred during the particular time. For Campaign 1, the member had six impressions, four clicks, and two other actions associated with Campaign 1 during the particular time. For Campaign 2, the member had four impressions, one click, and one other action associated with Campaign 2 during the particular time.

Further, bucket 400 also includes area 406 corresponding to other events and an other events count that represents the number of events not associated with any campaign. Accordingly, as shown in FIG. 4, the user data management system 200 counts and chronologically sorts one or more lists of events that do not belong to any campaign. As illustrated in FIG. 4, the member had three visits to xyz.com during the particular time.

Bucket 400 also includes area 408 that comprises total counts associated with the different types of events across all the campaigns referenced in the bucket 400 and a total count for the other actions associated with the campaigns referenced in the bucket 400. As illustrated in FIG. 4, the total count of impressions is ten, the total count of clicks is five, and the total count of other actions is three during the particular time.

In some example embodiments, bucket 400 also includes an area 410 that comprises a start time t0 and an end time t1.

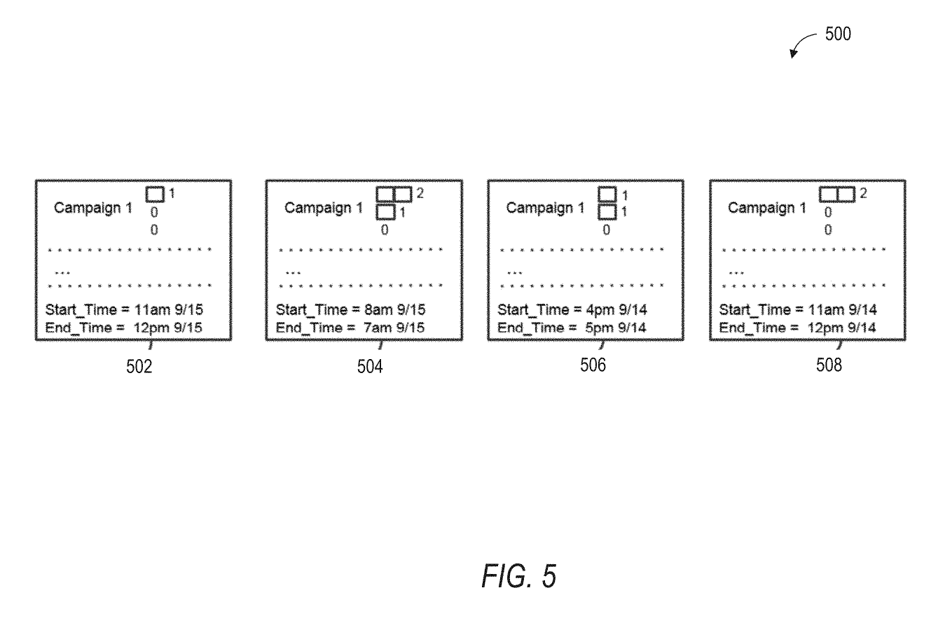

FIG. 5 is a diagram 500 illustrating a representation of a plurality of user data buckets associated with a member of the SNS for evaluating a frequency rule, according to some example embodiments. According to one example, the user data management system 200 receives, from an ad serving system, a request to evaluate the user data for a particular member according to a frequency rule of Campaign 1 that states “3 impressions in last 24 hours.” The current time is 9/15/2015 11:30 am. The user data management system 200 accesses buckets 502, 504, 506, and 508, illustrated in FIG. 5, based on determining that the buckets 502, 504, 506, and 508 include user event data that occurred in the last twenty-four hours.

The user data management system 200, based on accessing the metadata (e.g., the number of impressions, the number of clicks, or the number of other actions) associated with Campaign 1 in each of the buckets 502, 504, 506, and 508, determines the number of impressions for Campaign 1 in each of the buckets 502, 504, 506, and 508.

For example, for bucket 502 that corresponds to the hour between 11 am and 12 pm on September 15, the user data management system 200 determines that the member had one impression. The user data management system 200 performs no scanning of the list of impressions in the bucket 502 because all impressions in this bucket occurred before the current time. For bucket 504 that corresponds to the hour between 7 am and 8 am on September 15, the user data management system 200 determines that the member had two impressions. The user data management system 200 performs no scanning of the list of impressions in the bucket 504 because all impressions in this bucket occurred before the current time. For bucket 506 that corresponds to the hour between 4 pm and 5 pm on September 14, the user data management system 200 determines that the member had one impression. The user data management system 200 performs no scanning of the list of impressions in the bucket 506 because all impressions in this bucket occurred before the current time. For bucket 508 that corresponds to the hour between 11 am and 12 pm on September 14, the user data management system 200 determines that the expiration of the period of time corresponding to the bucket 508 is past the last twenty-four hours. The user data management system 200 scans and counts the list of impressions in the bucket 508 until the user data management system 200 identifies an impression that is older than twenty-four hours (e.g., has a timestamp older than 9/14/2015 11:30 am). According to this example, the user data management system 200 identifies one impression that is not older than twenty-four hours in the bucket 508. Based on aggregating the numbers of impressions from the buckets 502, 504, 506, and 508, the user data management system 200 determines that the total number of impressions associated with Campaign 1 for the particular member in the last twenty-four hours is five. Based on determining this total number of impressions, the user data management system 200 determines that the frequency rule associated with Campaign 1 is violated for the user event data associated with the particular member (e.g., five actual impressions exceed the maximum of three impressions specified in the rule). The user data management system 200 may communicate this determination to the ad serving system in response to the request to evaluate the frequency rule associated with the campaign.

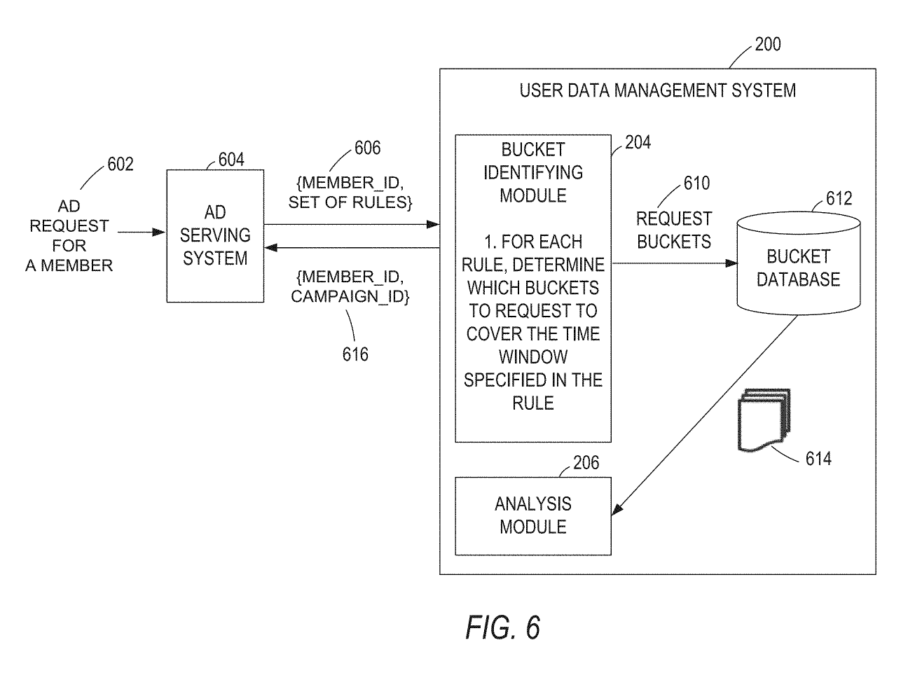

FIG. 6 is a diagram illustrating a data flow for evaluating rules against user events in user data buckets, and for excluding campaigns with violated rules, according to some example embodiments. As shown in FIG. 6, an ad serving system 604 receives a request 602 to identify an ad to be served to a member. The ad serving system 604 selects a list of potential campaigns for the member. The ad serving system transmits a communication 606 including a member identifier (ID) of the member and a one or more rules associated with one or more campaigns to the user data management system 200. The bucket identifying module 204 of the user data management system 200 identifies the time windows associated with the one or more rules and determines which buckets it needs to request from the bucket database 612 (e.g., user data store 126). The bucket identifying module 204 transmits a request 610 for the identified buckets to the bucket database 612. In response to the request 610, the bucket database 612 transmits the requested buckets to the analysis module 206 of the user data management system 200. The analysis module 206 uses the transmitted buckets (e.g., the user event data in the transmitted buckets) to evaluate the rules and to exclude campaigns with violated rules. A communication module of the user data management system 200 transmits a further communication 616 to the ad serving system 604. The communication 616 may include the member ID and a campaign ID that has a rule that has not been violated by the user event data associated with the member ID.

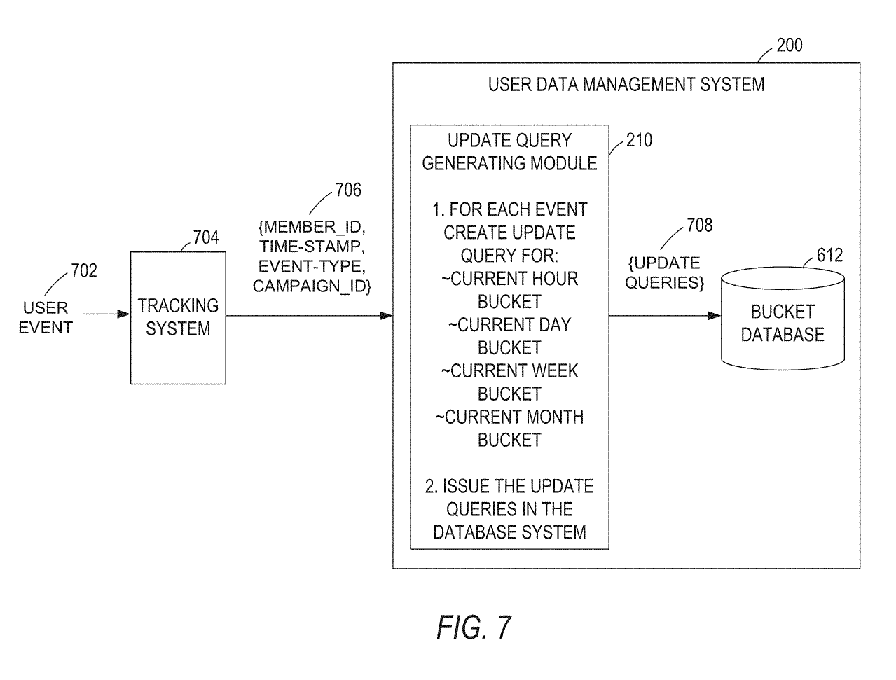

FIG. 7 is a diagram illustrating a data flow for updating user data buckets with user event data, according to some example embodiments. As shown in FIG. 6, a tracking system 704 for tracking user events receives a user event 702. In some example embodiments, the tracking system 704 converts each user event to a schema corresponding to the schema used by the user data management system 200. An example of such a schema includes a member ID, a timestamp of the user event, and an event type. Additionally, the schema may include a campaign ID.

The tracking system 704 may transmit the converted user event to the user data management system 200. The update query generating module 210 of the user data management system 200, for each event, creates an update query for one or more current buckets (e.g., the current hour bucket, the current day bucket, the current week bucket, or the current month bucket). The update query generating module 210 also issues the update queries to request the updating of the one or more buckets with the user event data received from the tracking system 704 and included in the update queries. The updating module 214 of the use data management system 200, based on the issued update queries, adds the user event to a list of user events of the type of the user event in each of the one or more current buckets. The updating module 214 also increases a list count that identifies a number of user events of the type of the user event in the list of the identified type, increases a total count of user events of the type across all campaigns in the one or more current buckets.

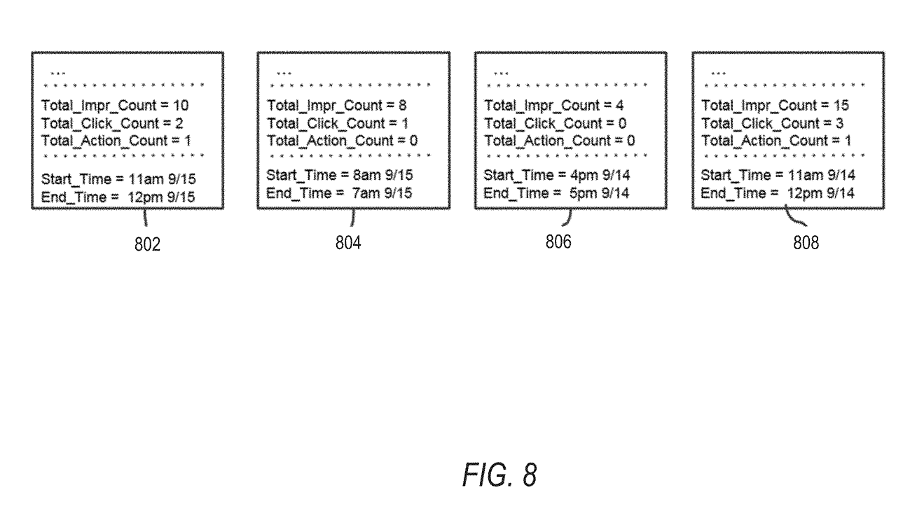

FIG. 8 is a diagram illustrating a representation of a plurality of user data buckets associated with a member of the SNS for evaluating a fraud rule, according to some example embodiments. According to one example, the user data management system 200 receives (e.g., from a fraud detection system) a request to evaluate the user data for a particular member according to a fraud rule that states “100 clicks in last 24 hours.” The current time is 9/15/2015 11:30 am. The particular member has activity only during four hours in the last twenty-four hours. The user data management system 200 accesses buckets 802, 804, 806, and 808, illustrated in FIG. 5, based on determining that the buckets 802, 804, 806, and 808 include user event data that occurred in the last twenty-four hours.

The user data management system 200, based on accessing the metadata (e.g., the number of clicks identified by the Total_Click_Count value) in each of the buckets 802, 804, 806, and 808, determines the total number of clicks in each of the buckets 802, 804, 806, and 808.

For example, for bucket 802 that corresponds to the hour between 11 am and 12 pm on September 15, the user data management system 200 determines that the member had one click. For bucket 804 that corresponds to the hour between 7 am and 8 am on September 15, the user data management system 200 determines that the member had one click. For bucket 806 that corresponds to the hour between 4 pm and 5 pm on September 14, the user data management system 200 determines that the member had zero clicks. For bucket 808 that corresponds to the hour between 11 am and 12 pm on September 14, the user data management system 200 determines that the member had three clicks. Based on aggregating the numbers of clicks from the buckets 802, 804, 806, and 808, the user data management system 200 determines that the total number of clicks for the particular member in the last twenty-four hours is six. Based on comparing the total number of clicks for the particular member in the last twenty-four hours (e.g., six) and the maximum number of clicks specified in the fraud rule (e.g., one hundred), the user data management system 200 determines that the clicking activity associated with the particular member in the last twenty-four hours does not violate the fraud rule. The user data management system 200 may communicate this determination to the fraud detection system in response to the request to evaluate the fraud rule against the user event data of the particular member.

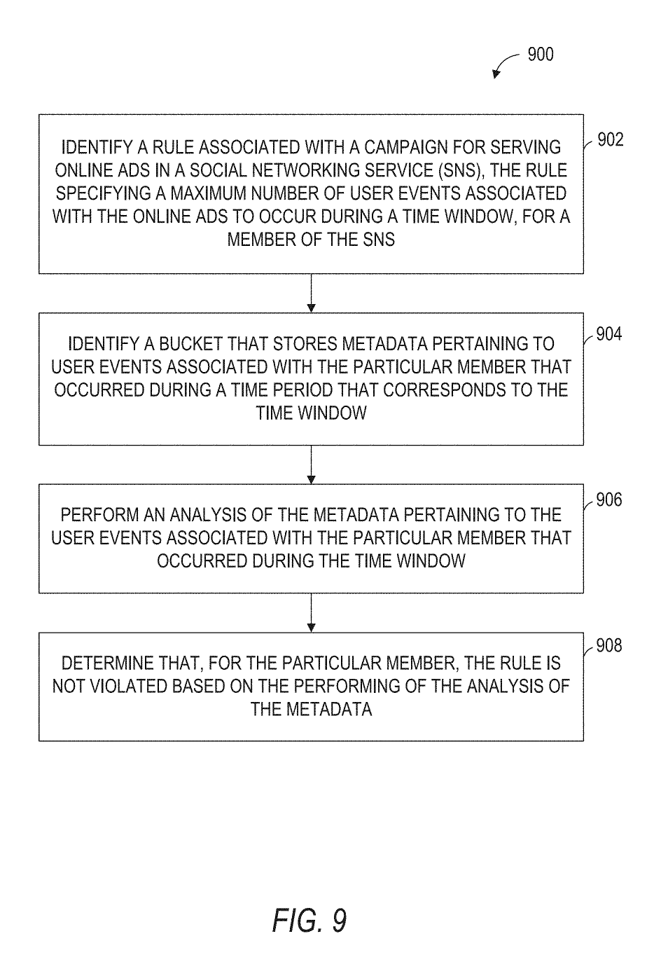

FIGS. 9-15 are flowcharts illustrating a method for managing and using data in a user data store, according to some example embodiments. The operations of method 900 illustrated in FIG. 9 may be performed using modules described above with respect to FIG. 2. As shown in FIG. 9, method 900 may include one or more of method operations 902, 904, 906, and 908, according to some example embodiments.

At operation 902, the rule identifying module 202 identifies a rule associated with a campaign for serving online ads in a social networking service (SNS). The rule may be stored in a database 216 (e.g., the campaign database 138). The rule specifies a maximum number of user events associated with the online ads included in the campaign to occur during a time window, for a member of the SNS. The rule may specify the maximum number of user events of a particular type (e.g., impressions, clicks, other events).

At operation 904, the bucket identifying module 204 identifies a bucket that stores metadata pertaining to user events associated with the particular member that occurred during a time period that corresponds to the time window specified in the rule. The identifying of the bucket may be based on the rule and a member identifier of a particular member of the SNS. In some instances, the metadata includes one or more values that identify one or more numbers of user events of one or more types that occurred during the time period associated with the bucket. In some instances, the metadata includes at least one of a count of impressions served to the particular member, a count of clicks by the particular member, or a count of other events associated with or by the particular member.

The bucket may also include one or more lists of user events (or descriptions of user events) associated with the particular member. Each of the one or more lists groups user events by type (e.g., impressions, clicks, or other events). The user events in each list may be ordered in chronological order, or reverse chronological order. After a new user event is registered (e.g., a new impression of an online ad is served to the member), the new user event is added to the list that corresponds to the type of user event in one or more buckets associated with the member. Also, after the new user event is registered, a count corresponding to the type of user event is increased for the campaign that includes the ad associated with the user event in the one or more buckets associated with the member. Further, a total count that corresponds to the type of user event and that tallies all user events of that type in all the campaigns referenced in the bucket is increased.

In various example embodiments, the bucket is associated with the particular member and includes a mapping from a campaign identifier of the campaign to at least one of a list of impressions associated with the campaign identifier provided to the particular member, a list of clicks associated with the campaign identifier by the particular member, or a list of other events associated with the campaign identifier and the particular member.

In some example embodiments, the identifying of the bucket includes selecting one or more buckets from a plurality of buckets associated with the particular member based on determining that the one or more buckets include metadata pertaining to one or more user events that occurred during time periods associated with the one or more buckets. Certain buckets associated with the member that do not include data (e.g., user event data, metadata, etc.) for the time periods associated with the certain buckets are not selected for analysis.

In various example embodiments, the identifying of the bucket includes identifying one or more buckets, including the bucket, that store user events associated with the particular member and that are associated with one or more time periods, including the time period, that include the time window specified in the rule. For example, to evaluate a rule that specifies a thirty-six hour window of time, one possible evaluation plan is to use two daily buckets. The user data management system 200 identifies a first daily bucket that corresponds to today (as a calendar day). The user data management system 200 also identifies a second daily bucket that corresponds to yesterday. Yesterday's bucket has to be scanned (e.g., by the user data management system 200) because it may contain events that are outside the 36-hour window.

In certain example embodiments, the identifying of the bucket includes identifying the one or more buckets, including the bucket, that are associated with one or more time periods, including the time period, that correspond to the time window specified in the rule. For example, to evaluate a rule that specifies a twenty-four hour period of time, one possible evaluation plan is to use two daily buckets, as described in the example above. Alternately, to evaluate a rule that specifies a twenty-four hour period of time, the user data management system 200 may use up to twenty-five hourly buckets. For example, the user data management system 200 uses twenty-five buckets if every bucket includes events that took place during the time associated with the particular bucket. The user data management system 200 uses less than twenty-five buckets if certain hours during the twenty-four hour window specified by the rule are void of user activity.

At operation 906, the analysis module 206 performs an analysis of the metadata pertaining to the user events associated with the particular member that occurred during the time window specified in the rule.

At operation 908, the analysis module 206 determines that, for the particular member, the rule is not violated based on the performing of the analysis of the metadata. According to some example embodiments, the determining that, for the particular member, the rule is not violated includes determining that an ad included in the campaign should be displayed in a user interface of a device associated with particular member.

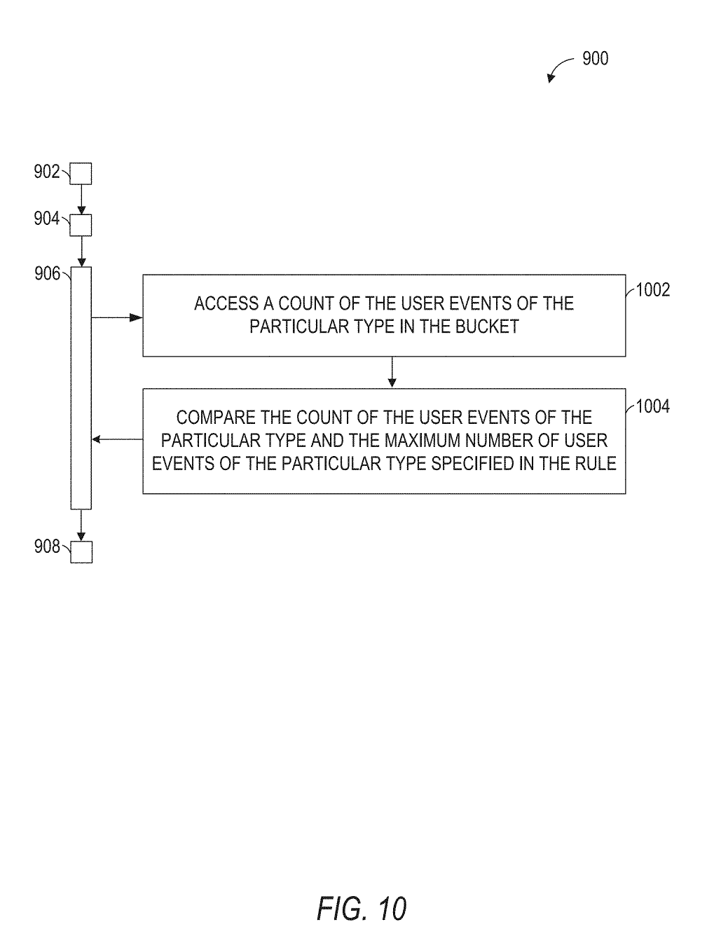

According to some example embodiments, the identifying of the rule, the identifying of the bucket, and the determining that, for the particular member, the rule is not violated are performed in real time based on an indication that the particular member has logged into a web site of the SNS. Further details with respect to the operations of the method 900 are described below with respect to FIGS. 10-15.

As shown in FIG. 10, method 900 may include one or more of operations 1002 and 1004, according to some example embodiments. In various example embodiments, the rule specifies a maximum number of user events of a particular type, and the metadata includes counts of user events of one or more types.

Operation 1002 may be performed as part (e.g., a precursor task, a subroutine, or a portion) of operation 906, in which the analysis module 206 performs an analysis of the metadata pertaining to the user events associated with the particular member that occurred during the time window specified in the rule. At operation 1002, the analysis module 206 accesses a count of the user events of the particular type in the bucket.

Operation 1004 is performed after operation 906. The analysis module 206 compares the count of the user events of the particular type and the maximum number of user events of the particular type specified in the rule.

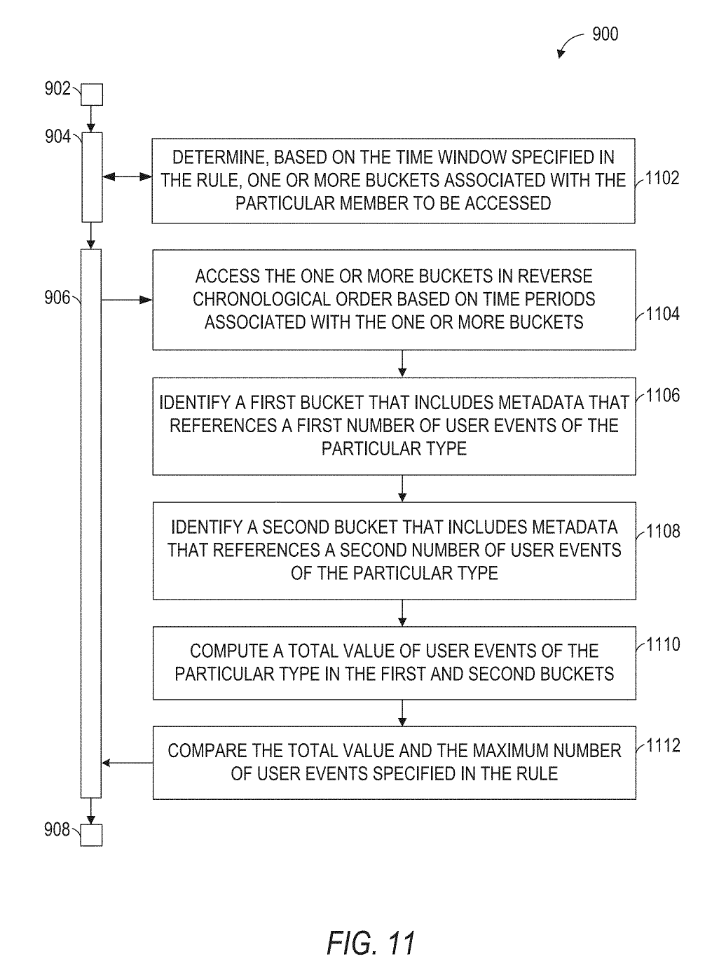

As shown in FIG. 11, method 900 may include one or more of operations 1102, 1104, 1106, 1108, 1110, and 1112, according to some example embodiments. In various example embodiments, the rule specifies a maximum number of user events of a particular type.

Operation 1102 may be performed as part (e.g., a precursor task, a subroutine, or a portion) of operation 904, in which the bucket identifying module 204 identifies a bucket that stores metadata pertaining to user events associated with the particular member that occurred during a time period that corresponds to the time window specified in the rule.

At operation 1102, the bucket identifying module 204 determines, based on the time window specified in the rule, one or more buckets associated with the particular member to be accessed. In some example embodiments, the determining, based on the time window specified in the rule, of the one or more buckets includes matching the time window and one or more time periods associated with the one or more buckets.

Operation 1104 may be performed as part (e.g., a precursor task, a subroutine, or a portion) of operation 906, in which the analysis module 206 performs an analysis of the metadata pertaining to the user events associated with the particular member that occurred during the time window specified in the rule. At operation 1104, the analysis module 206 accesses the one or more buckets in reverse chronological order based on time periods associated with the one or more buckets.

At operation 1106, the analysis module 206 identifies a first bucket of the one or more buckets that includes metadata that references a first number of user events of the particular type.

At operation 1108, the analysis module 206 identifies a second bucket of the one or more buckets that includes metadata that references a second number of user events of the particular type.

At operation 1110, the analysis module 206 computes a total value of user events of the particular type in the first and second buckets.

At operation 1112, the analysis module 206 compares the total value of user events and the maximum number of user events specified in the rule.

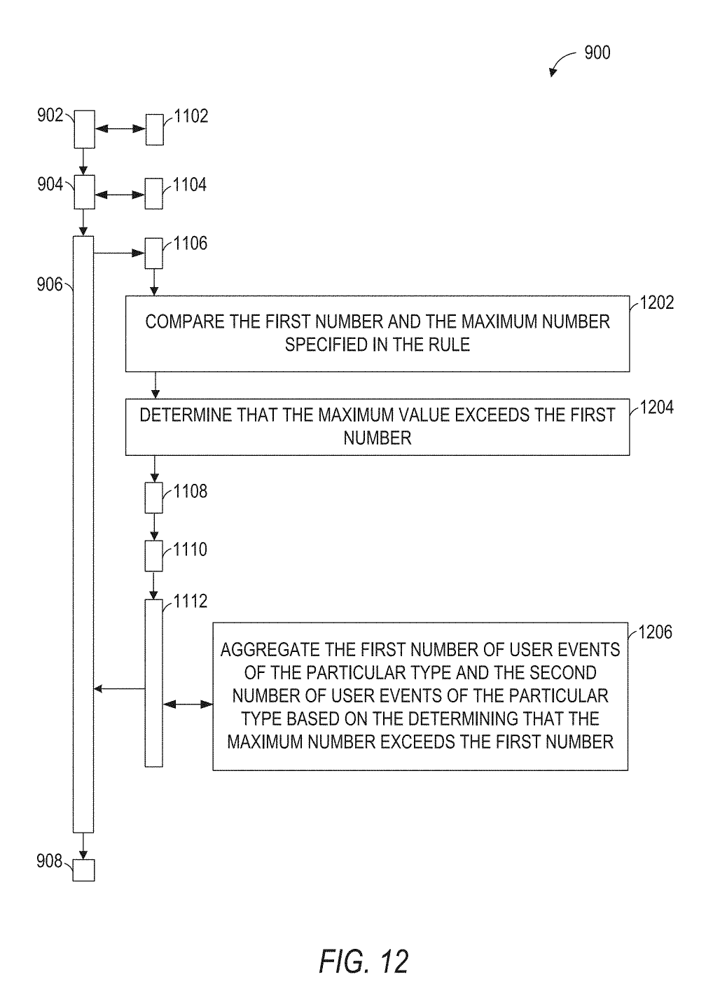

As shown in FIG. 12, method 900 may include one or more of operations 1202, 1204, and 1206, according to some example embodiments. Operation 1202 may be performed after operation 1106, in which the analysis module 206 identifies a first bucket of the one or more buckets that includes metadata that references a first number of user events of the particular type. At operation 1202, the analysis module 206 compares the first number of user events of the particular type and the maximum number specified in the rule.

At operation 1204, the analysis module 206 determines that the maximum value exceeds the first number. The determining that the maximum value exceeds the first number may be based on the comparison of the first number of user events of the particular type and the maximum number specified in the rule.

In some example embodiments, the analysis module 206 determines, based on the comparing of the first number of user events of the particular type and the maximum number specified in the rule, that the first number of user events exceeds the maximum value specified in the rule. Based on the determining that the first number of user events exceeds the maximum value specified in the rule, the analysis module 206 stops performing further analysis of data in other buckets (e.g., does not analyze the metadata in the second bucket). The analysis module 206 further determines that, for the particular member, the rule is violated based on the determination that the first number of user events exceeds the maximum value specified in the rule.

Operation 1206 may be performed after operation 1112, in which the analysis module 206 compares the total value of user events and the maximum number of user events specified in the rule. At operation 1206, the analysis module 206 aggregates the first number of user events of the particular type and the second number of user events of the particular type based on the determining that the maximum number exceeds the first number.

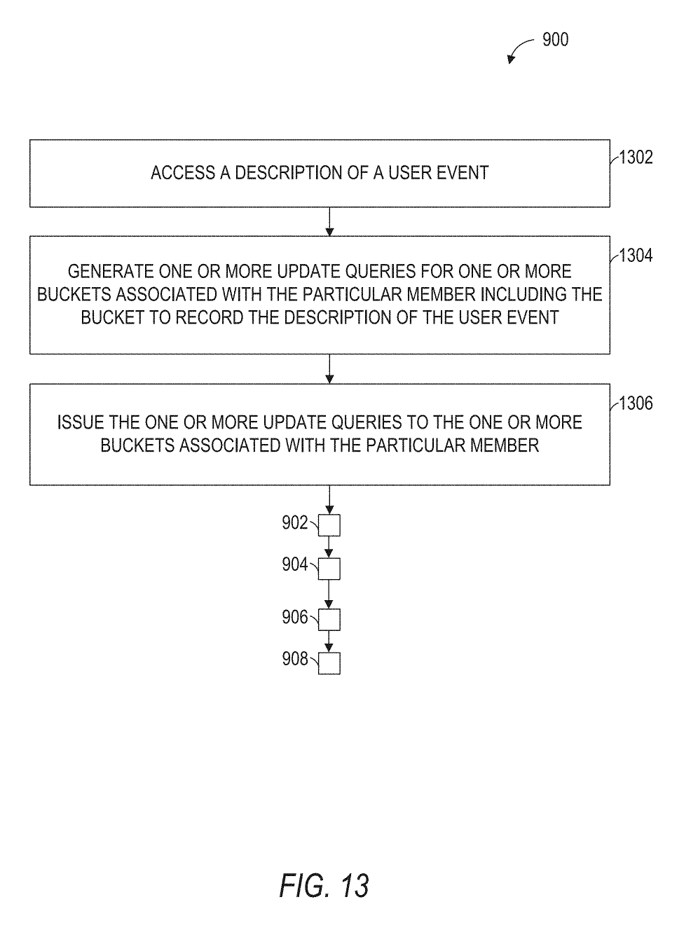

As shown in FIG. 13, method 900 may include one or more of operations 1302, 1304, and 1306, according to some example embodiments. Operation 1302 may be performed before operation 902, in which the rule identifying module 202 identifies a rule associated with a campaign for serving online ads in the SNS.

At operation 1302, the access module 208 accessing (e.g., receives) a description of a user event. The description of the user event may be included in a communication received by the user data management system 200 from a tracking system that tracks user events. The description includes at least one of a member identifier of the particular member, a timestamp of the user event, a type of the user event, or a campaign identifier.

Operation 1304 is performed after operation 1302 and before operation 902. At operation 1304, the update query generating module 210 generates one or more update queries for one or more buckets associated with the particular member including the bucket to record the description of the user event. The generating of the one or more update queries may be based on the accessing of the description of the user event.

Operation 1306 is performed after operation 1304 and before operation 902. At operation 1306, the update query generating module 210 issues the one or more update queries to the one or more buckets associated with the particular member. The issuing of the one or more update queries may be based on the generating of the one or more update queries. The one or more update queries may reference (e.g., include) the description of the user event.

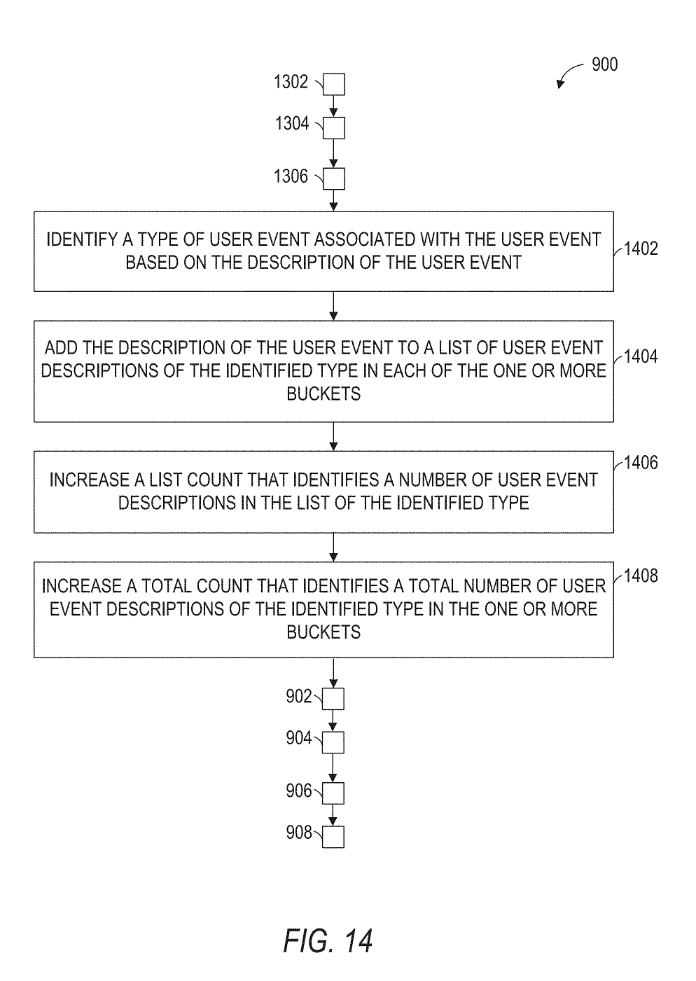

As shown in FIG. 14, method 900 may include one or more of operations 1402, 1404, 1406, and 1408, according to some example embodiments. Operation 1402 may be performed after operation 1306, and before operation 902, in which the rule identifying module 202 identifies a rule associated with a campaign for serving online ads in the SNS. At operation 1402, the event type identifying module 212 identifies the type of user event associated with the user event based on the description of the user event.

At operation 1404, the updating module 214 adds the description of the user event to a list of user event descriptions of the identified type in each of the one or more buckets. The adding of the description of the user event to a list of user event descriptions of the identified type in each of the one or more buckets may be based on the issuing of the one or more update queries.

At operation 1406, the updating module 214 increases a list count that identifies a number of user event descriptions in the list of the identified type. The increasing of the list count that identifies a number of user event descriptions in the list of the identified type may be based on the issuing of the one or more update queries.

At operation 1408, the updating module 214 increases a total count that identifies a total number of user event descriptions of the identified type in the one or more buckets. The increasing of the total count that identifies the total number of user event descriptions in one or more lists of user event descriptions including the list of the identified type may be based on the issuing of the one or more update queries.

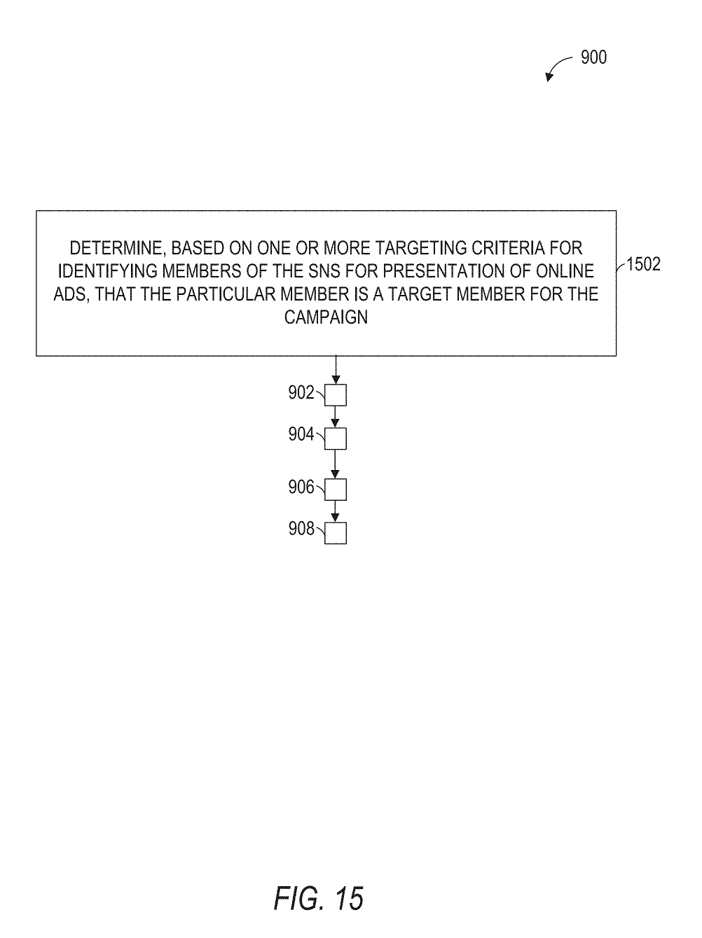

As shown in FIG. 15, method 900 may include operation 1502, according to some example embodiments. Operation 1502 may be performed before operation 902, in which the rule identifying module 202 identifies a rule associated with a campaign for serving online ads in the SNS. At operation 1502, the targeting module 214 determines that the particular member is a target member for the campaign. The determining that the particular member is a target member for the campaign may be based on one or more targeting criteria for identifying members of the SNS for presentation of online ads.

### Example Mobile Device

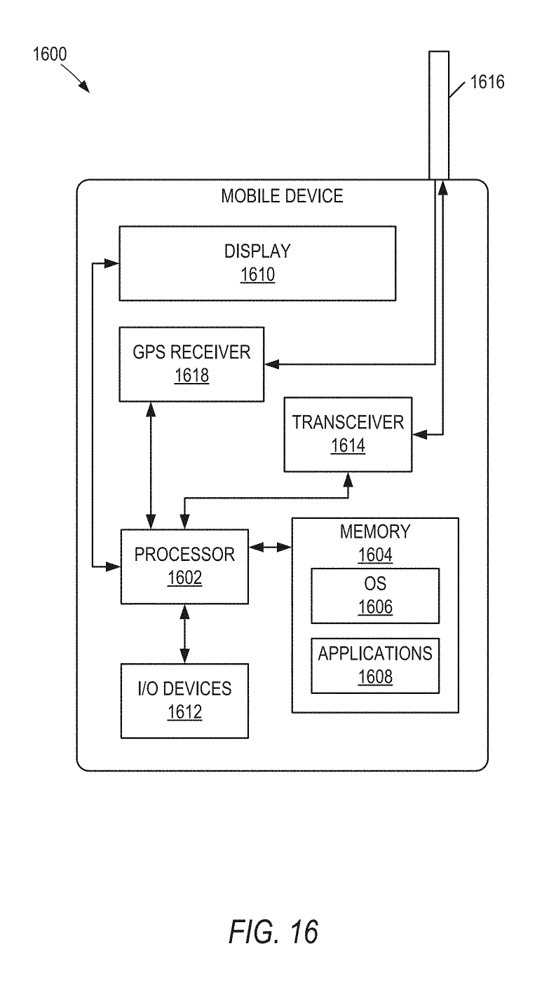

FIG. 16 is a block diagram illustrating a mobile device 1600, according to an example embodiment. The mobile device 1600 may include a processor 1602. The processor 1602 may be any of a variety of different types of commercially available processors 1602 suitable for mobile devices 1600 (for example, an XScale architecture microprocessor, a microprocessor without interlocked pipeline stages (MIPS) architecture processor, or another type of processor 1602). A memory 1604, such as a random access memory (RAM), a flash memory, or other type of memory, is typically accessible to the processor 1602. The memory 1604 may be adapted to store an operating system (OS) 1606, as well as application programs 1608, such as a mobile location enabled application that may provide LBSs to a user. The processor 1602 may be coupled, either directly or via appropriate intermediary hardware, to a display 1610 and to one or more input/output (I/O) devices 1612, such as a keypad, a touch panel sensor, a microphone, and the like. Similarly, in some embodiments, the processor 1602 may be coupled to a transceiver 1614 that interfaces with an antenna 1616. The transceiver 1614 may be configured to both transmit and receive cellular network signals, wireless data signals, or other types of signals via the antenna 1616, depending on the nature of the mobile device 1600. Further, in some configurations, a GPS receiver 1618 may also make use of the antenna 1616 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

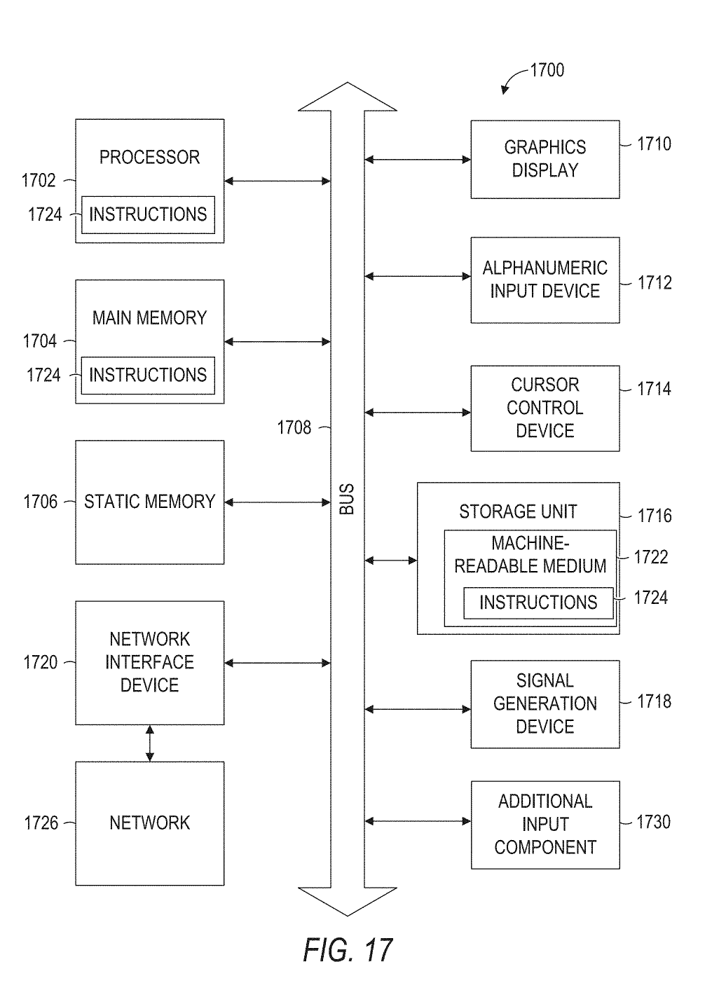

FIG. 17 is a block diagram illustrating components of a machine 1700, according to some example embodiments, able to read instructions 1724 from a machine-readable medium 1722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 17 shows the machine 1700 in the example form of a computer system (e.g., a computer) within which the instructions 1724 (e.g., software, a program, an application, an applet, an app, or other executable code) for causing the machine 1700 to perform any one or more of the methodologies discussed herein may be executed, in whole or in part.

In alternative embodiments, the machine 1700 operates as a standalone device or may be connected (e.g., networked) to other machines. In a networked deployment, the machine 1700 may operate in the capacity of a server machine or a client machine in a server-client network environment, or as a peer machine in a distributed (e.g., peer-to-peer) network environment. The machine 1700 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1724, sequentially or otherwise, that specify actions to be taken by that machine. Further, while only a single machine is illustrated, the term “machine” shall also be taken to include any collection of machines that individually or jointly execute the instructions 1724 to perform all or part of any one or more of the methodologies discussed herein.

The machine 1700 includes a processor 1702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1704, and a static memory 1706, which are configured to communicate with each other via a bus 1708. The processor 1702 may contain microcircuits that are configurable, temporarily or permanently, by some or all of the instructions 1724 such that the processor 1702 is configurable to perform any one or more of the methodologies described herein, in whole or in part. For example, a set of one or more microcircuits of the processor 1702 may be configurable to execute one or more modules (e.g., software modules) described herein.

The machine 1700 may further include a graphics display 1710 (e.g., a plasma display panel (PDP), a light emitting diode (LED) display, a liquid crystal display (LCD), a projector, a cathode ray tube (CRT), or any other display capable of displaying graphics or video). The machine 1700 may also include an alphanumeric input device 1712 (e.g., a keyboard or keypad), a cursor control device 1714 (e.g., a mouse, a touchpad, a trackball, a joystick, a motion sensor, an eye tracking device, or other pointing instrument), a storage unit 1716, an audio generation device 1718 (e.g., a sound card, an amplifier, a speaker, a headphone jack, or any suitable combination thereof), and a network interface device 1720.

The storage unit 1716 includes the machine-readable medium 1722 (e.g., a tangible and non-transitory machine-readable storage medium) on which are stored the instructions 1724 embodying any one or more of the methodologies or functions described herein. The instructions 1724 may also reside, completely or at least partially, within the main memory 1704, within the processor 1702 (e.g., within the processor's cache memory), or both, before or during execution thereof by the machine 1700. Accordingly, the main memory 1704 and the processor 1702 may be considered machine-readable media (e.g., tangible and non-transitory machine-readable media). The instructions 1724 may be transmitted or received over the network 1726 via the network interface device 1720. For example, the network interface device 1720 may communicate the instructions 1724 using any one or more transfer protocols (e.g., hypertext transfer protocol (HTTP)).

In some example embodiments, the machine 1700 may be a portable computing device, such as a smart phone or tablet computer, and have one or more additional input components 1730 (e.g., sensors or gauges). Examples of such input components 1730 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1724 for execution by the machine 1700, such that the instructions 1724, when executed by one or more processors of the machine 1700 (e.g., processor 1702), cause the machine 1700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A method comprising:
enhancing a machine of a user data management system, the enhancing of the machine of the user data management system including incorporating one or more modules into one or more memories of the user data management system, the one or more modules configuring one or more hardware processors of the user data management system to perform operations comprising:
identifying a rule associated with a campaign for serving online ads in a social networking service (SNS), the rule specifying a maximum number of user events of a particular type associated with the online ads included in the campaign to occur during a time window, for a member of the SNS;
based on the time window specified in the rule and a member identifier of a particular member of the SNS, identifying one or more buckets that store metadata pertaining to user events associated with the particular member in the one or more memories of the user data management system, the user events being tracked by a machine of a tracking system during a time period that corresponds to the time window specified in the rule;
performing an analysis of the metadata pertaining to the user events associated with the particular member that were tracked by the machine of a tracking system during the time window specified in the rule, the performing of the analysis including:
accessing the one or more buckets in reverse chronological order based on time periods associated with the one or more buckets,
identifying a first number of user events of the particular type in a first bucket of the one or more buckets based on the metadata included in the first bucket that references the first number of user events of the particular type,
identifying a second number of user events of the particular type in a second bucket of the one or more buckets based on the metadata included in the second bucket that references the second number of user events of the particular type,
computing a total value of user events of the particular type in the first and second buckets based on the identified first number of user events and the second number of user events, and
comparing the total value of user events and the maximum number of user events of the particular type specified in the rule;
determining that, for the particular member, the rule is not violated based on the performing of the analysis of the metadata; and
based on the determining that the rule is not violated, causing a display of an ad included in the campaign in a user interface of a device associated with particular member.

2. The method of claim 1, wherein the determining that, for the particular member, the rule is not violated includes determining that an ad included in the campaign should be displayed in a user interface of a device associated with the particular member.

3. The method of claim 1, wherein the metadata includes at least one of a count of impressions served to the particular member, a count of clicks by the particular member, or a count of other events associated with the particular member.

4. The method of claim 1, wherein the rule specifies the maximum number of user events of a particular type.

5. The method of claim 1, wherein the metadata includes one or more values that identify one or more numbers of user events of one or more types that occurred during the time period associated with the one or more bucket.

6. The method of claim 1, wherein the identifying of the one or more buckets includes selecting one or more buckets from a plurality of buckets associated with the particular member based on determining that the one or more buckets include metadata pertaining to one or more user events that occurred during time periods associated with the one or more buckets.

7. The method of claim 1, wherein the identifying of the one or more buckets includes identifying one or more buckets, that store user events associated with the particular member and that are associated with one or more time periods that include the time window specified in the rule.

8. The method of claim 1, wherein the rule specifies the maximum number of user events of a particular type, wherein the metadata includes counts of user events of one or more types, and wherein the performing of the analysis includes:
accessing a count of the user events of the particular type in a bucket of the one or more buckets; and
comparing the count of the user events of the particular type and the maximum number of user events of the particular type specified in the rule.

9. (canceled)

10. The method of claim 1, wherein the determining, based on the time window specified in the rule, of the one or more buckets includes matching the time window and one or more time periods associated with the one or more buckets.

11. The method of claim 1, wherein the performing of the analysis further includes:
comparing the first number of user events of the particular type and the maximum number specified in the rule; and
determining that the maximum value exceeds the first number,
wherein the computing of the total value includes aggregating the first number of user events of the particular type and the second number of user events of the particular type based on the determining that the maximum number exceeds the first number.

12. The method of claim 1, further comprising:
accessing a description of a user event, the description including at least one of a member identifier of the particular member, a timestamp of the user event, a type of the user event, or a campaign identifier;
based on the accessing of the description of the user event, generating one or more update queries for one or more buckets associated with the particular member to record the description of the user event; and
based on the generating of the one or more update queries, issuing the one or more update queries to the one or more buckets associated with the particular member, the one or more update queries referencing the description of the user event.

13. The method of claim 12, further comprising:
identifying the type of user event associated with the user event based on the description of the user event;
based on the issuing of the one or more update queries, adding the description of the user event to a list of user event descriptions of the identified type in the one or more buckets;
increasing a list count that identifies a number of user event descriptions in the list of the identified type; and
increasing a total count that identifies a total number of user event descriptions of the identified type in the one or more buckets.

14. The method of claim 1, further comprising:
determining, based on one or more targeting criteria for identifying members of the SNS for presentation of online ads, that the particular member is a target member for the campaign.

15. The method of claim 1, wherein the identifying of the rule, the identifying of the one or more buckets, and the determining that, for the particular member, the rule is not violated are performed in real time based on an indication that the particular member has logged into a web site of the SNS.

16. The method of claim 1, wherein the one or more buckets are associated with the particular member and include a mapping from a campaign identifier of the campaign to at least one of a list of impressions associated with the campaign identifier provided to the particular member, a list of clicks associated with the campaign identifier by the particular member, or a list of other events associated with the campaign identifier and the particular member.

17. A user data management system comprising:
one or more hardware processors;
one or more modules incorporated into the data management system to enhance a machine of the user data management system, the enhancing including configuring the one or more hardware processors to perform operations comprising:
identifying a rule associated with a campaign for serving online ads in a social networking service (SNS), the rule specifying a maximum number of user events of a particular type associated with the online ads included in the campaign to occur during a time window, for a member of the SNS;
based on the time window specified in the rule and a member identifier of a particular member of the SNS, identifying one or more buckets that store metadata pertaining to user events associated with the particular member in the one or more memories of the user data management system, the user events being tracked by a machine of a tracking system during a time period that corresponds to the time window specified in the rule;
performing an analysis of the metadata pertaining to the user events associated with the particular member that were tracked by the machine of a tracking system during the time window specified in the rule, the performing of the analysis including:
accessing the one or more buckets in reverse chronological order based on time periods associated with the one or more buckets,
identifying a first number of user events of the particular type in a first bucket of the one or more buckets based on the metadata included in the first bucket that references the first number of user events of the particular type,
identifying a second number of user events of the particular type in a second bucket of the one or more buckets based on the metadata included in the second bucket that references the second number of user events of the particular type,
computing a total value of user events of the particular type in the first and second buckets based on the identified first number of user events and the second number of user events, and
comparing the total value of user events and the maximum number of user events of the particular type specified in the rule;
determining that, for the particular member, the rule is not violated based on the performing of the analysis of the metadata; and
based on the determining that the rule is not violated, causing a display of an ad included in the campaign in a user interface of a device associated with particular member.

18. The system of claim 17, wherein the operations further comprise:
accessing a description of a user event, the description including at least one of a member identifier of the particular member, a timestamp of the user event, a type of the user event, or a campaign identifier;
based on the accessing of the description of the user event, generating one or more update queries for the one or more buckets associated with the particular member to record the description of the user event; and
based on the generating of the one or more update queries, issuing the one or more update queries to the one or more buckets associated with the particular member, the one or more update queries referencing the description of the user event.

19. The system of claim 18, wherein the operations further comprise:
identifying the type of user event associated with the user event based on the description of the user event;
based on the issuing of the one or more update queries, adding the description of the user event to a list of user event descriptions of the identified type in the one or more buckets;
increasing a list count that identifies a number of user event descriptions in the list of the identified type; and
increasing a total count that identifies a total number of user event descriptions of the identified type in the one or more buckets.

20. A non-transitory machine-readable storage medium comprising instructions that, when incorporated into a user data management system as one or more modules implemented by one or more hardware processors of the user data management system, cause the one or more hardware processors to perform operations to enhance a machine of the user data management system, the operations comprising:
identifying a rule associated with a campaign for serving online ads in a social networking service (SNS), the rule specifying a maximum number of user events of a particular type associated with the online ads included in the campaign to occur during a time window, for a member of the SNS;
based on the time window specified in the rule and a member identifier of a particular member of the SNS, identifying one or more buckets that store metadata pertaining to user events associated with the particular member in the one or more memories of the user data management system, the user events being tracked by a machine of a tracking system during a time period that corresponds to the time window specified in the rule;
performing an analysis of the metadata pertaining to the user events associated with the particular member that were tracked by the machine of a tracking system during the time window specified in the rule, the performing of the analysis including:
accessing the one or more buckets in reverse chronological order based on time periods associated with the one or more buckets,
identifying a first number of user events of the particular type in a first bucket of the one or more buckets based on the metadata included in the first bucket that references the first number of user events of the particular type,
identifying a second number of user events of the particular type in a second bucket of the one or more buckets based on the metadata included in the second bucket that references the second number of user events of the particular type,
computing a total value of user events of the particular type in the first and second buckets based on the identified first number of user events and the second number of user events, and
comparing the total value of user events and the maximum number of user events of the particular type specified in the rule:
determining that, for the particular member, the rule is not violated based on the performing of the analysis of the metadata; and
based on the determining that the rule is not violated, causing a display of an ad included in the campaign in a user interface of a device associated with particular member.
